(19) United States
(12) Patent Application Publication
(10) Pub. No.: US 2004/0085366 A1
(43) Pub. Date: May 6, 2004

(54) Method for maintaining state information in a browser session across multiple web sites

(76) Inventors: Ward Scott Foster, Boise, ID (US); Charles J. Gazdik, Boise, ID (US); Shell Sterling Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/283,195

(22) Filed: Oct. 30, 2002

(51) Int. Cl. G09G 5/00

(52) U.S. Cl. 345/854; 345/749

(57) ABSTRACT

A method, system, program product, and means for maintaining state information for a browser instance when multiple browser instances are instantiated, the method comprising the steps: instantiating a first browser instance; associating first state information with the first browser instance and storing the association; instantiating a second browser instance; associating second state information, which is different from the first state information, with the second browser instance and storing the association; accessing the instantiated first browser instance; and retrieving the first state information for the first browser instance.

### BACKGROUND OF THE INVENTION

It frequently occurs that users open multiple browser sessions on their imaging client. Sometimes it is advantageous to share state information across all of these different browser sessions.

Prior art describes the use of a browser extension to maintain state information (e.g. user profile information) across multiple browser sessions and web content from multiple web sites. This sharing of state information does not permit the user to use different browser sessions to process different sets of data. For example, a user that uses web based imaging web sites to process imaging compositions may want to open multiple browser sessions to process different graphics compositions or documents. However, all browser sessions will be required to interact with the same active document. Additionally, all of the user browser windows may not be updated/refreshed when the user selects an active document or composition in one of the browser instances. (Note that the word “active” means the document that will appear by default in the user's browser instance.) A failure to update/refresh would cause the user to believe that a web browser was operating on a particular page shown in a preview image, when, in fact, the active document or composition that was active for the web service had been changed by another different browser instance.

Cookies have been used to save state information in the prior art. However, cookies are only accessible by the website that created them and are not accessible from multiple independent websites. Cookies also are not tied to any particular browser session or instance and therefore do not allow the mapping of state information to a particular browser session.

### SUMMARY OF THE INVENTION

The present invention comprises in one embodiment, a method for maintaining state information for a browser instance when multiple browser instances are instantiated, comprising the steps: instantiating a first browser instance; associating first state information with the first browser instance and storing the association; instantiating a second browser instance; associating second state information, which is different from the first state information, with the second browser instance and storing the association; accessing the instantiated first browser instance; and retrieving the first state information for the first browser instance.

The present invention comprises in a further embodiment, a system for maintaining state information for a browser instance when multiple browser instances are instantiated, comprising: a component for instantiating multiple instances of a browser; a component for associating different state information with each different browser instance and storing the association; and component for allowing different content from multiple respective independent web sites to access state information associated with a browser instance that loaded that content.

The present invention comprises in a yet further embodiment, a program product for maintaining state information for a browser instance when multiple browser instances are instantiated, comprising machine readable program code including: code for associating different state information with each different browser instance and storing the association; and code for allowing different content from multiple respective independent web sites to access state information associated with a browser instance that loaded that content.

The present invention comprises in yet a further embodiment, a browser extension for maintaining state information for a browser instance when multiple browser instances are instantiated, comprising machine readable program code including: code for obtaining a different session ID for each different instance of the browser; code for associating different state information with each different browser instance session ID and storing the association; and code for allowing different content from multiple respective independent web sites to access state information associated with a browser instance that loaded that content.

The present invention comprises in a further embodiment, a system for maintaining state information for a browser instance when multiple browser instances are instantiated, comprising: means for instantiating multiple instances of a browser; means for associating different state information with each different browser instance and storing the association; and means for allowing different content from multiple respective independent web sites to access state information associated with a browser instance that loaded that content.

### BRIEF DESCRIPTION OF THE DRAWINGS

FIG. 1 is a schematic block diagram of an overall configuration which would utilize an embodiment of the present invention.

FIG. 2 is a schematic block diagram of a flowchart of an embodiment of the present invention.

FIG. 3 is a schematic block diagram of a flowchart of a further embodiment of the present invention.

FIG. 4 is a schematic block diagram of an imaging client that may be utilized to implement the present invention.

FIG. 5 is a schematic block diagram of a programming product embodiment of the present invention.

FIGS. 6A-6E comprise a schematic block diagram of a flowchart of example operations which could be performed by an embodiment of the present invention.

### DETAILED DESCRIPTION OF THE EMBODIMENTS

The following pending application is hereby incorporated by reference, in its entirety: “WEB BASED IMAGING SERVICE THAT CACHES PRE-PROCESSED CONTENT TO PROVIDE BETTER PERFORMANCE” by Shell Simpson, Ward Foster, and Kris Livingston, Ser. No. 09/924,060, filed on Aug. 8, 2001.

The following definitions are provided to assist in obtaining an understanding of the invention.

“API”. An application programming interface (API) is a library of programmatic methods provided by a system of some kind (an example is a web-based imaging system, as in the present invention) that enables client programs (web content operating within the browser is one example) to interact with that system. One method of creating an API is to create a library. For example, in Java (a registered trademark of Sun Microsystems, Inc.) language, a library (conventionally called a jar file) is created by defining a class or classes, compiling the class or classes, and grouping the class or classes into a library. For example, the following class could be created:

class BaseConversionAPI {static public String convertBaseToBase(String inNumber, int inBase, int outBase) {//Code for returning a string representing inNumber converted to outBase}}

That class would then be compiled with the command:

javac.exe BaseConversionAPI.java.

NOTE: Programs are typically stored in text files, which are “compiled” in order to create “object files” which contain the executable (or interpretable) instructions. In this case, the program is contained in the file BaseConversionAPI.java. The act of compiling creates a file named “BaseConversionAPI.class” containing instructions for a specific computing architecture (in this case the Java Virtual Machine) corresponding to the program.

Next in this example, a Jar file would be created:

jar.exe cvf BaseConversionAPI.tar BaseConversionAPI.class

This command creates a “library” file containing the BaseConversionAPI class. This last step is not absolutely required. In some instances, APIs are provided as files containing executable instructions (such as the BaseConversionAPI.class file).

For references regarding the creation of APIs see:

http://www.library.yale.edu/orbis2/public/activity/API.html

Note that APIs to network services would be created to be accessible through a remote invocation technology such as CORBA, JAVA-RMI, DCOM, RPC, or SOAP. A wide variety of printed references are available that describe how APIs can be created to be accessible through a remote invocation technology, such as one of the technologies noted above.

Although libraries are referred to as APIs through out this patent application, it is important to realize that an API is not really a library; an API is an interface that a library implements. However, to simplify the text in this patent application an API and the implementation of an API as a library will be used interchangeably.

“Client-Server”. A model of interaction in a distributed system in which a program at one site sends a request to a program at another site and waits for a response. The requesting program is called the “client,” and the program that responds to the request is called the “server.” In the context of the World Wide Web, the client is a “Web browser” (or simply “browser”) which runs on the computer of a user; the program which responds to browser requests by serving Web pages, or other types of Web content, and is commonly referred to as a “Web server.”

“Composition.” Composition, also referred to as a “graphics composition,” comprises a file with links to graphic data serviced as a single unit, i.e., a graphic. The file also usually includes information on the placement of those graphics on a sequence of canvases. It describes how to combine one or more graphics from one or more sources onto a sequence of canvasses, in a variety of different ways. The use of compositions allows multiple compositions to reference a graphic in a graphic store without having to duplicate the graphic.

“Content”. A set of executable instructions that is served by a server to a client and is intended to be executed by the client so as to provide the client with certain functionality. Web content refers to content that is meant to be executed by operation of a Web browser. Web content, therefore, may non-exhaustively include one or more of the following: HTML code, SGML code, XML code, XSL code, CSS code, Java applet, JavaScript and C-“Sharp” code.

“Extension”. A browser extension may comprise a set of code configured to respond to the execution of generic access instructions downloaded in web content by generating/mapping to corresponding client specific commands of an imaging client. A browser extension may be implemented/thought of as an application programming interface (API). Generic access instructions from the web content, when executed, cause the browser extension API to map to specific instructions in the imaging client to access and manipulate system resources. It should be recognized that there are many other ways (both hardware and software) to implement this functionality. The present invention is not limited to any one way.

“Native Library”. A native library is a code module that has been compiled to machine language (binary instructions that can be directly executed by the CPU) for a particular hardware platform. A native library may be compiled from source code that may include operating system specific code (e.g. API calls for process IDs and other items).

“Profile.” The word “profile” or “user profile” is a repository of user information that may include one or more references. Each reference would, by way of example but not by way of limitation, be implemented by a URL reference, or in some cases a pointer, socket number or other backroom detail. The reference for the user profile could be to a location within an imaging client itself, or to a location external to the imaging client, such as a server. In some embodiments, there may be an internal user profile and an external user profile, with each being located on a different server. Each user profile might include, by way of example but not by way of limitation, user identification information and at least a reference to all or a portion of a personal imaging repository for that user profile and references to one or more composition stores. It should be noted that there may be multiple internal and/or external user profiles, selectable automatically or manually based on one or more criteria. For example, there could be a different internal and external user profile for each different imaging client that the user may use, with the particular internal or external user profile selected by providing the user identification information, other information including location information, and the imaging client machine information to an imaging extension.

“Web Site.” A computer system that serves informational content over a network using the standard protocols of the World Wide Web. Typically, a Web site corresponds to a particular Internet domain name, such as “hp.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users. Importantly, a Web Site can have additional functionality, for example, a Web site may have the ability to print documents, scan documents, etc.

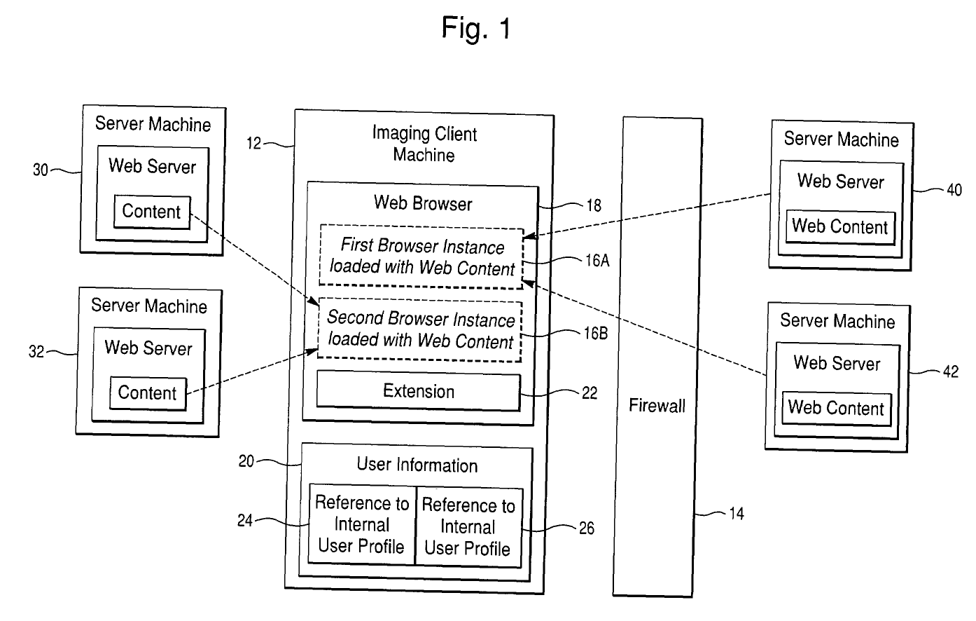

Referring now to FIG. 1, an imaging client machine 12 is shown behind a firewall 14. The imaging client 12 may access by means of a web browser 18 web content 16 from servers 30 and 32 inside the firewall 14, and web content from servers 40 and 42 outside of the firewall.

Referring now to the individual components, the imaging client 12, by way of example, but not by way of limitation, would typically include a configuration with the aforementioned web browser 18, a storage module of some type 20 with user information such as user profiles 24 and 26 and other information, an extension 22, and some form of user interface (not shown), e.g., a keyboard and display device. Generally, the web browser 18 would be implemented under control of a microprocessor.

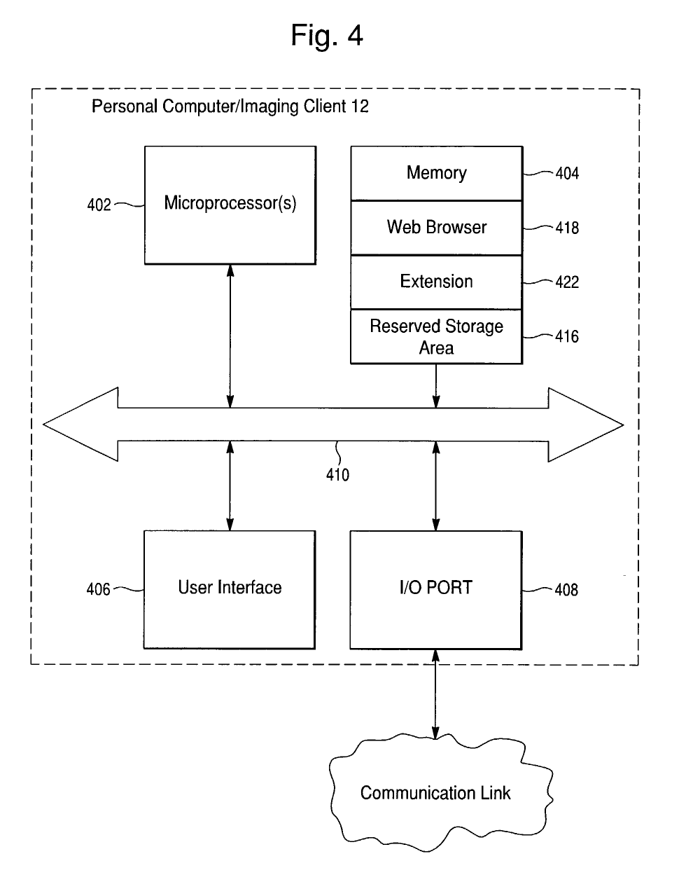

An example imaging client 12 of FIG. 1, in the form of a personal computer, is shown in FIG. 4. FIG. 4 is a high level diagram of a personal computer/imaging client 12. As shown, the personal computer 12 includes a processor 402, a memory 404, the Web browser 418, the extension 422, a reserved storage area 416, one or more user interfaces (keyboard and/or display for example) 406, and input/output (I/O) port(s) 408. All of these components are connected by one or more local buses 410. The I/O port 408 links to the servers previously described via the communications link. The processor 402 is used to execute the WEB browser imaging client 12.

In operation, the browser 18 initially accesses a web site and using appropriate request commands (HTTP for the current generation of browsers), downloads therefrom web content. As noted by the definition herein, the web content 16 includes a set of executable instructions that are intended to be executed in the browser 18 so as to provide the imaging client 12 with predetermined functionality. These executable instructions comprise generic access instructions that are system wide instructions, expressed in some language (e.g., Java) and that call the methods of the extension 22 API to perform various web imaging operations. Such generic access instructions can be, by way of example but not by way of limitation, Java, JavaScript, C-sharp instructions. The system wide standard typically specifies “generic access instructions,” “generic access requests,” and “target graphics.”

A variety of functionality could be provided by the web content. For example, the web content might include executable instructions for causing the imaging client 12 to display a document available on the accessed web site. Another web content downloaded from a printer web site might include executable instructions for displaying a print button, and if the print button is clicked, causing the imaging client to generate a print job and transmit the print job to a printer. Accordingly, the web content 16 in FIG. 1 refers to a set of executable instructions that are downloaded into the web browser 18 to perform a service requested by the user.

The web browser executes the web content, whether it is HTML interpreted/executed by the browser to display marks on a user's screen or Java and JavaScript or some other appropriate language. As previously noted, the web content contains executable instructions that use the API provided by the extension 22 to access various imaging client resources.

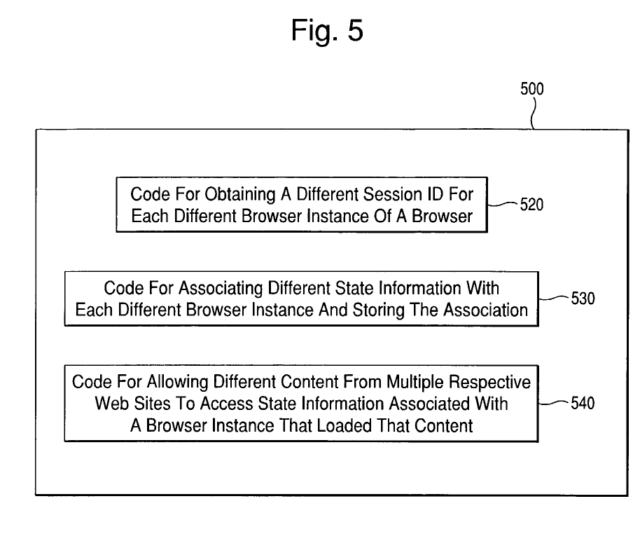

The present invention is directed to a method, program product 500 (FIG. 5) and system for maintaining state information for a browser instance when multiple browser instances are instantiated. By way of example, but not by way of limitation, the state information could comprise an active document ID or a user ID. The program product, as indicated by block 500 in FIG. 5, comprises code 520 for obtaining a different session ID for each different instance of a browser, code 530 for associating different state information with each different session ID and storing the association, and code 540 for allowing different content from multiple respective websites to access state information associated with a browser instance that loaded that content. By way of example, but not by way of limitation, one or more of the methods recited in program product 500 may be implemented in the browser extension 22 for the browser in the imaging client 12.

In a specific example for an extension, when a web page is loaded into the imaging client 12, as web content, it will typically include a JAVA Applet. The JAVA Applet will include in the applet a tag that specifies a JAVA runtime environment to utilize. If the Applet tag specifies the JAVA runtime environment that was extended by extension 22, then the Applet will run/cause to be executed that extension 22. In other words, the Applet that loads as a result of the Applet tag has access to the extension code. Thus, this extension code runs as part of the JAVA runtime environment.

An advantage to the use of an extension is that it allows the functionality to avoid security restrictions that apply normally to an Applet running in the context of a browser. For example, Applets running in the context of a browser do not have access to the client file systems or to a native library. As noted in the definition, a native library comprises programs compiled to run on the host machine OS and the host machine hardware. In particular, it is not possible to make a JAVA native interface call from an Applet running in a browser. However, the Applet running in a browser can call a JAVA native interface (JNI call) from an extension.

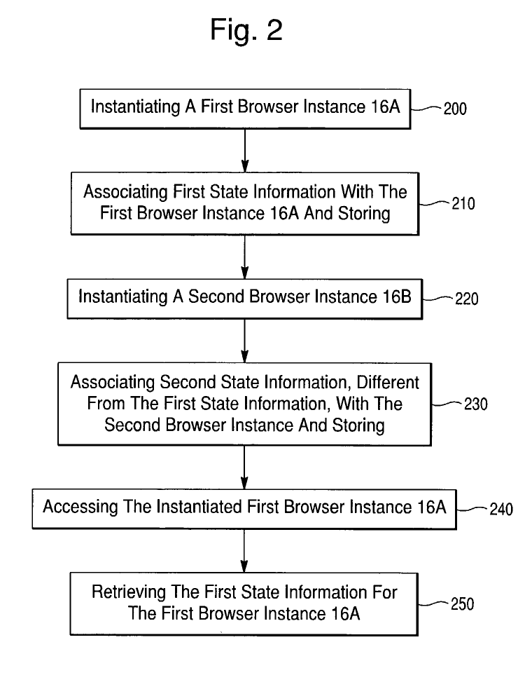

An embodiment of the operation of the method of the present invention is shown is the flowchart of FIG. 2. In block 200, a first browser instance 16A is instantiated. Such instantiation is typically performed by the operating system for the client via a user manually or automatically starting another instance of the browser program.

In block 210, first state information is associated with the first browser instance 16A. There are a variety of methods of performing this association step to be discussed below.

In block 220, a second browser instance 16B is instantiated by the operating system or via another convenient method. In block 230, second state information, different from the first state information, is associated with the second browser instance 16B and the association is stored.

In block 240, the first browser instance 16A is accessed by clicking over or another convenient method. In block 250, the first state information for the first browser instance 16A is retrieved for use with the first browser.

A feature of the present invention is the ability to associate in blocks 210 and 230 different state information with different browser instances. This association could be accomplished in a number of different ways. For example, the state information could be stored as a static variable in address space for the method of the browser. This storage could be either in a Java extension itself, in a native library, or other convenient storage.

As another example, the associating step could be accomplished by mapping a session ID for a browser instance to state information for that instance and storing that association and then making that state information accessible to web content loaded in the browser. However, in order to obtain a session ID for a browser instance, access is required to OS (operating system) calls to determine the session ID for a particular window in which a browser instance is running. This access to OS calls (WIN 32 API, for example) can be obtained through the native library.

The extension method and/or code thus includes code for associating different state information with each different browser instance. This association of the state information and the browser instance is then stored. This association may be stored in any convenient storage accessible to the extension. In one embodiment, this association storage would comprise a table accessible to the extension. As other examples of storage, the association could be stored in the address space for the browser method or in a native library. This state information can then be accessed by subsequent website content loaded into this browser instance by calling the extension (API) and requesting any state information that is associated with that browser instance.

It should be noted that the term “session ID” is used generically to refer to any OS dependent mechanism (like, for instance, a process ID) that identifies a particular browser session.

As an alternative to an extension, signed content may be utilized in combination with a native library to create a mapping between the session ID for a browser instance and the state information for that browser instance.

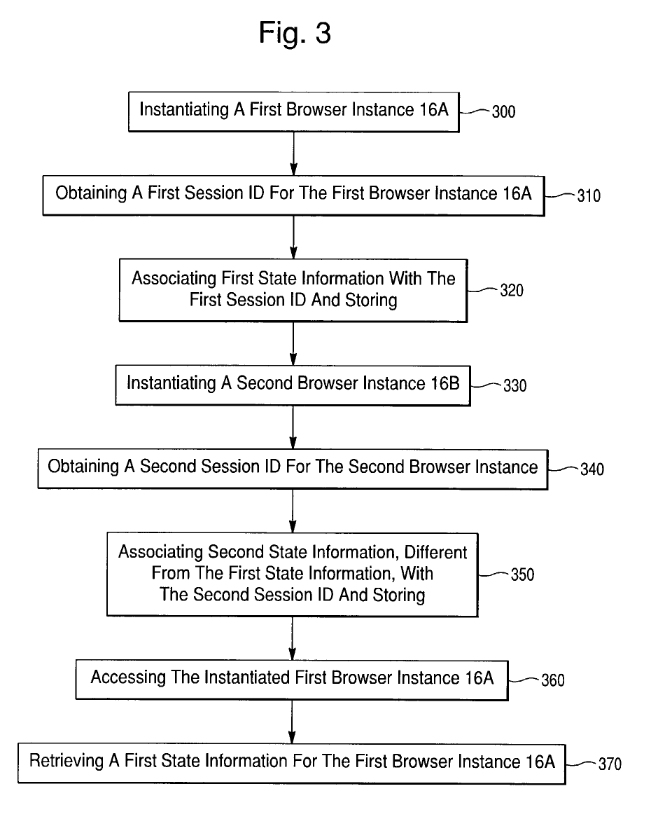

Referring now to FIG. 3, a flowchart of an embodiment for associating a session ID for a browser instance and state information is shown. In block 300, a first browser instance 16A is instantiated. In block 310, a first session ID for the first browser instance 16A is obtained. In block 320, first state information for the browser instance 16A is associated with the first session ID.

Referring to block 330, a second browser instance 16B is instantiated. In block 340, a second session ID for the second browser instance is obtained. In block 350, second state information for the second browser instance 16B is associated with the second session ID. Note that this second state information, such as a different document, will be different from the first state information.

In block 360, the instantiated first browser instance is accessed. In block 370, the first state information for this first browser instance 16A is obtained.

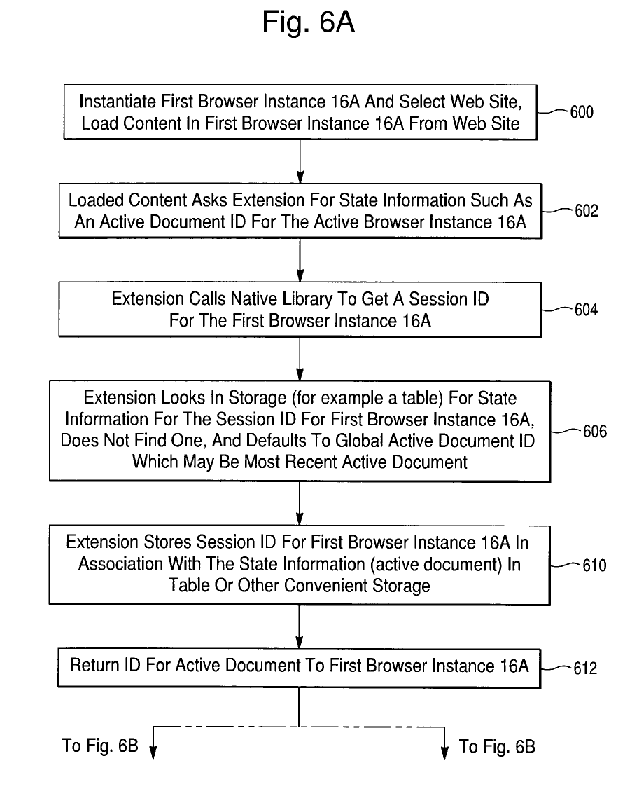

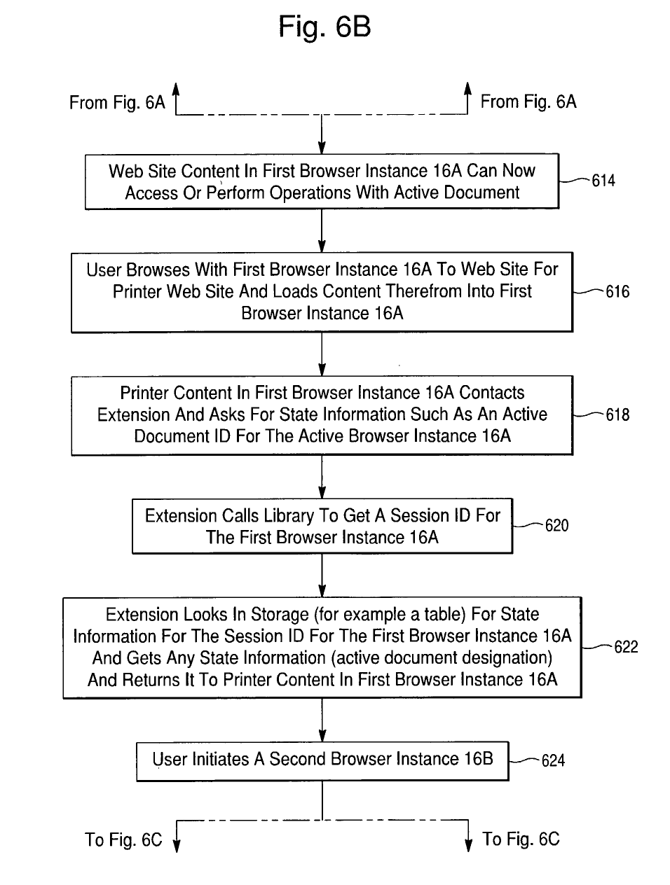

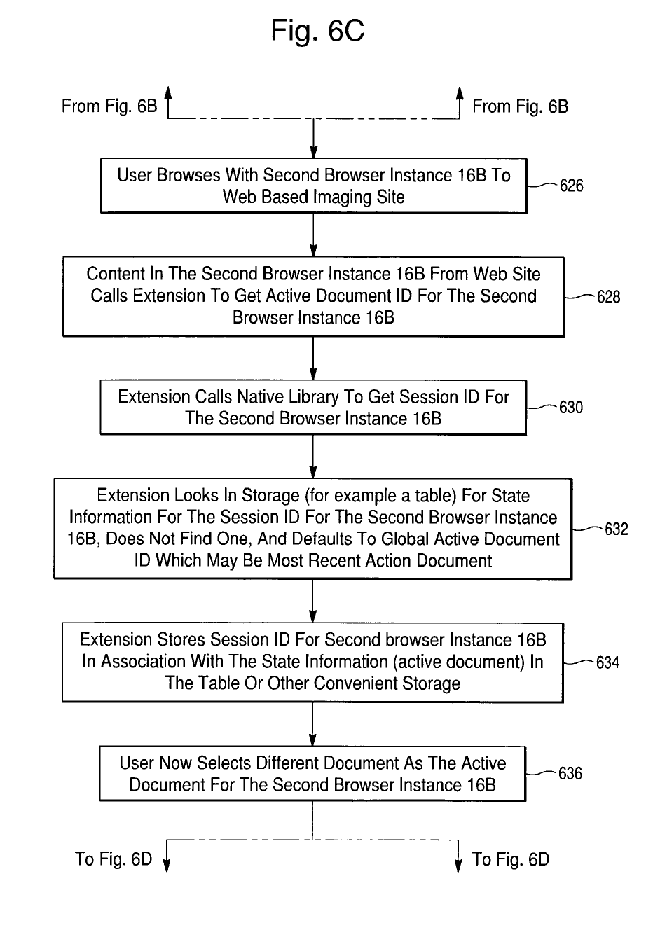

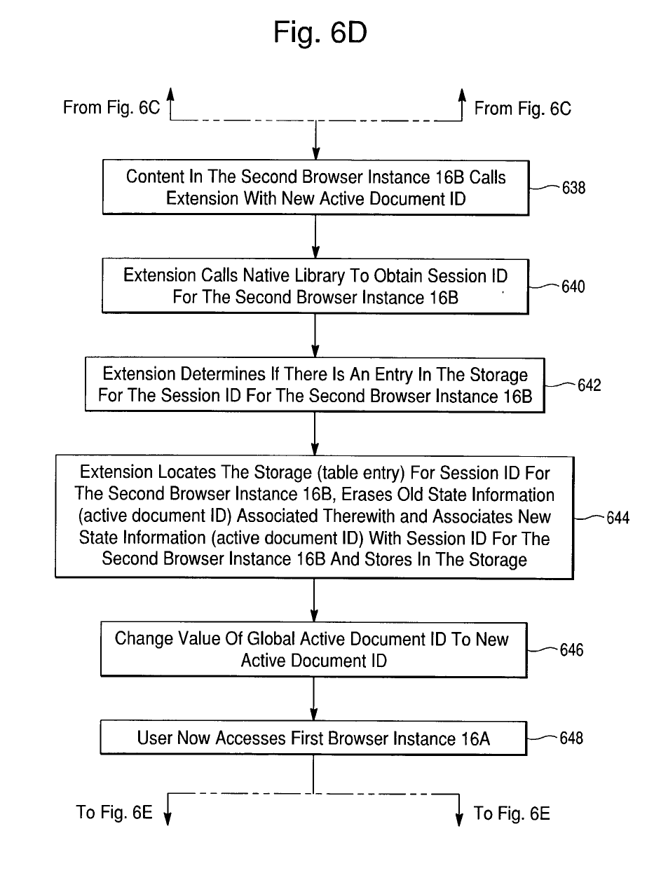

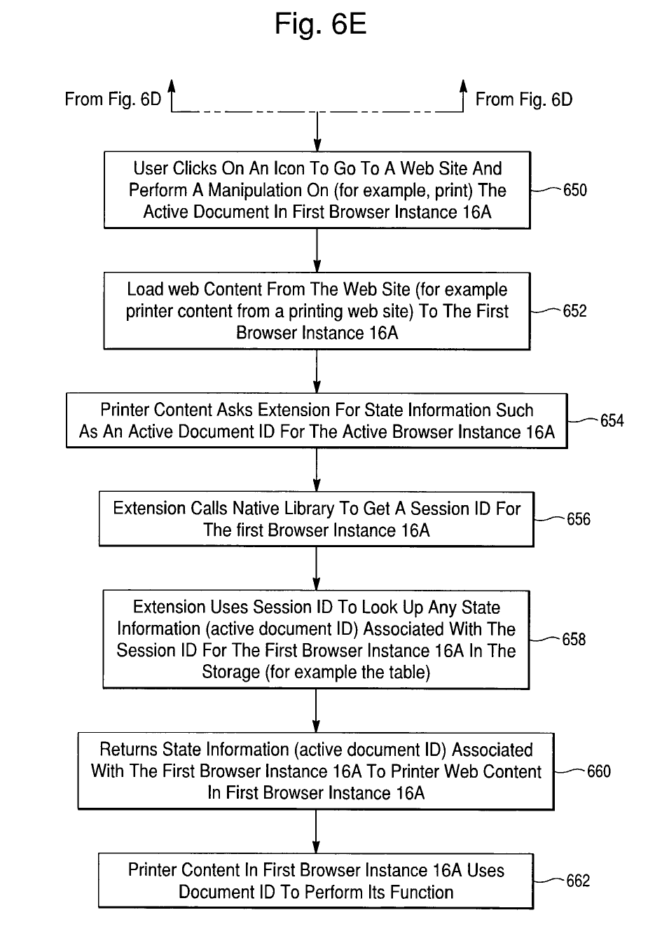

Referring now to FIGS. 6A-6E, a more detailed flow chart example is provided implementing one embodiment of the present invention. Referring to block 600, the first browser instance is instantiated. At this time, the user may browse with this first browser instance 16A to a website for processing images, such as documents. By way of example, but not by way of limitation, the website may be a web based imaging home page. The web content from this website is loaded in the first browser instance 16A.

In block 602, the web content asks the browser extension to determine if there is any state information for the active browser. Such information might comprise the active document ID for that first browser instance. In block 604, the extension calls a native library to make an OS call to obtain a session ID for the first browser instance 16A.

In block 606, the extension looks in storage, such as a table for state information associated with the session ID for the first browser instance 16A, does not find such state information in the table because the first browser instance 16A has just been opened, and defaults to a global active document which may be the most recent active document for the system.

In block 610, the extension stores the session ID for the first browser instance 16A in association with state information (the active document) for that first browser instance in the table. In block 612, the active document ID is returned to the first browser instance 16A. In block 614, the web content accesses or performs operations with the active document identified by the active document ID.

In block 616, the user browses with the first browser instance 16A to a new website, such as for a printer. The printer website content is loaded into the first browser instance 16A.

The printer website content contacts the extension API and asks the extension for the active document ID. In block 620, the extension asks the native library (such as a DLL) for a session ID for the first browser instance 16A. With the session ID for the first browser instance, the extension looks up that ID in the table and obtains any state information associated therewith such as an active document ID and return this information to the printer website content in the first browser instance 16A. In block 624, the user then instantiates a second browser instance 16B. Typically, this would be accomplished by double clicking on the browser icon.

The user then browses with the second browser instance 16B to a web based imaging site. In block 628, the content in the second browser instance 16B from that web site causes the extension to get the active document ID for the second browser instance 16B.

In block 630, the extension causes the native library to obtain a session ID for the second browser instance 16B. In block 632, the extension looks in storage (the table) for a session ID for the second browser instance 16B, but does not find that session ID in the table and defaults to the global active document ID.

In block 634, the extension then stores the session ID for the second browser instance and this global document ID in association in storage (the table). In block 636, the user via the second browser instance 16B selects a different document as the active document for the second browser instance 16B. In block 638, the content in the second browser instance calls the extension with the new active document ID. In block 640, the extension calls to the native library to obtain the session ID for the second browser instance 16B. In block 642, the extension determines if there is an entry in the table for the session ID for the second browser instance 16B. In block 644, the extension locates the table entry for the session ID for the second browser instance 16B, erases the old state information (the active document ID) associated therewith and associates the new state information (the active document ID) with this session ID for the second browser instance 16B and stores in storage (the table).

In block 646, the value for the global active document ID is changed to the new active document ID so that the global active document ID represents the most recently selected document. In block 648, the user now accesses the first browser instance 16A. In block 650, the user clicks on the print active document command displayed in his imaging client by the content in the first browser instance 16A.

In block 652, the web content from the printer website for printing content for the first browser instance 16A is loaded into the browser. In block 654, the printer content asks the extension for the active document ID for the first browser instance 16A. In block 656, the extension asks the native library what is the session ID for the first browser instance 16A. In block 658, the extension uses the session ID to look up in the table to determine if any state information (active document ID) is associated with the session ID for the first browser instance 16A.

In block 660, the state information (the active document ID) associated with the first browser instance in the table is returned to the printer web content in the first browser instance 16A. In block 662, the printer content in the first browser instance 16A uses that document ID to perform its function.

Note that the browser also may simply store the state information (e.g. active document ID) as static data within the extension or native library itself without using a session ID. This is possible because each browser session is a separate process and therefore maintains separate address spaces where the state information would be saved. Since in most cases the process ID (as the session ID) to the state information is simply being mapped, the state information could be stored in the extension or native library without having to use a session ID). However, using a session ID is more robust in that it will work with browsers that may use the same JVM process for all browser sessions.

Accordingly, it can be seen that the present invention allows content from multiple web sites to share the same state information. This feature is particularly advantageous to systems like web based imaging systems wherein content for multiple independent web sites participate in an imaging system that uses a browser extension and potentially multiple browser instances. Ideally, the system would prefer to maintain state information (e.g., the “active” composition) as the user navigates to several websites. The present invention maps the state information to each browser instance to thereby allow the user to have multiple independent browser sessions that operate on different sets of user data.

Thus, the present invention allows the sharing of state information across multiple browser sessions and across multiple web sites.

The foregoing description of an embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method for maintaining state information for a browser instance when multiple browser instances are instantiated, comprising the steps:
instantiating a first browser instance;
associating first state information with the first browser instance and storing the association;
instantiating a second browser instance;
associating second state information, which is different from the first state information, with the second browser instance and storing the association;
accessing the instantiated first browser instance; and
retrieving the first state information for the first browser instance.

2. The method as defined in claim 1, wherein the associating steps comprise storing the state information as static data in address space for a process for the browser.

3. The method as defined in claim 1, wherein the associating steps comprise storing the association in a browser extension.

4. The method as defined in claim 2, wherein the storage is in a native library.

5. The method as defined in claim 1, wherein the associating steps are performed by signed content.

6. The method as defined in claim 2, wherein the storage is in a browser extension.

7. The method as defined in claim 1, wherein the associating first state information step comprises
obtaining a first session ID for the first browser instance; and
associating the first state information with the first session ID for the first browser instance and storing the association; and
wherein the associating second state information step comprises
obtaining a second session ID for the second browser instance;
associating the second state information with the second session ID for the second browser instance and storing the association;

8. The method as defined in claim 7, wherein the associating of state information with session ID steps are performed by a browser extension.

9. The method as defined in claim 8, wherein the associating of state information with session ID steps include storing the respective associations in a table in the browser extension.

10. The method as defined in claim 1, wherein the state information comprises an active document ID.

11. A system for maintaining state information for a browser instance when multiple browser instances are instantiated, comprising:
a component for instantiating multiple instances of a browser;
a component for associating different state information with each different browser instance and storing the association; and
a component for allowing different content from multiple respective independent web sites to access state information associated with a browser instance that loaded that content.

12. The system as defined in claim 11, wherein the component for associating and the component for allowing different content to access state information comprise a browser extension.

13. A program product for maintaining state information for a browser instance when multiple browser instances are instantiated, comprising machine readable program code including:
code for associating different state information with each different browser instance and storing the association; and
code for allowing different content from multiple respective independent web sites to access state information associated with a browser instance that loaded that content.

14. A browser extension for maintaining state information for a browser instance when multiple browser instances are instantiated, comprising machine readable program code including:
code for obtaining a different session ID for each different instance of the browser;
code for associating different state information with each different browser instance session ID and storing the association; and
code for allowing different content from multiple respective independent web sites to access state information associated with a browser instance that loaded that content.

15. A system for maintaining state information for a browser instance when multiple browser instances are instantiated, comprising:
means for instantiating multiple instances of a browser;
means for associating different state information with each different browser instance and storing the association; and
means for allowing different content from multiple respective independent web sites to access state information associated with a browser instance that loaded that content.
